(19) United States
(12) Patent Application Publication
(10) Pub. No.: US 2019/0197596 A1
(43) Pub. Date: Jun. 27, 2019

(54) SYSTEM, APPARATUS, AND METHOD FOR INTEGRATING A PLURALITY OF SUPPLIER SYSTEMS

(71) Applicant: OCTRAVES TECHNOLOGY SDN BHD, Kuala Lumpur (MY)

(72) Inventors: Mohammad Tabraiz FEHAM, Kuala Lumpur (MY); Nadeem AHMED, Kuala Lumpur (MY)

(73) Assignee: OCTRAVES TECHNOLOGY SDN BHD, Kuala Lumpur (MY)

(21) Appl. No.: 16/221,508

(22) Filed: Dec. 15, 2018

(30) Foreign Application Priority Data
Dec. 21, 2017 (MY) PI 2017704970

(51) Int. Cl. G06Q 30/06; G06F 9/54

(52) U.S. Cl. CPC G06Q 30/0625; G06F 9/547

(57) ABSTRACT

A system for integrating a plurality of supplier system, each of which employs a least on application programming interface, by which a plurality of suppliers provides at least on product, said system comprising: a module for designing at least on template for the product; and module for establishing connection with the interface of the supplier system; a module for generating at least on action for a call of the interface, wherein each action includes a request envelope and a response envelope; a module for designing at least on flow of a plurality of actions; a module for mapping said request and response envelopes; and a module for generating a plurality of codes or classes based on the mapping, wherein the codes or classes are capable of including the supplier in the result of at least on search for the product. Also provided are an apparatus and a method for integrating the plurality of supplier systems.

This invention relates to a system, apparatus, and method for integrating a plurality of supplier systems, wherein each of the supplier systems employs at least one application programming interface by which a plurality of suppliers provides at least one product, more especially travel product.

### BACKGROUND OF THE INVENTION

Suppliers employ diverse application programming interfaces (hereinafter referred as “API”) for systems on which they supply products. Integrating the supplier systems is cumbersome and takes significant amount of time to accomplish.

US 20020046301 A1 discloses a system and a method for integrating disparate networks for use in electronic communication and commerce. The system comprises a series of network connection elements including automatic plug-ins, configurable plug-ins and visual-based system-built customised extensions. These elements are used according to embodiments of the system to serve as building blocks for connecting one or more disparate systems together. In some embodiments of the system, these building blocks can be arranged in a visual-based environment to help facilitate integration of the systems in question. In the preferred implementation, an API server provides a four-pronged solution to provide integrated data access. The four components of this implementation are an internal integration engine, ETL and B2B application adapters, an XML Gateway, and an application-specific high-performance interface.

EP 2897344 A1 discloses a computer system for interconnecting content requesting clients with a plurality of content provider platforms offering content, the computer system comprises: a client interface arranged for transaction-oriented message exchange with the content requesting clients; a runtime module arranged to map content-provider-specific data formats and content-provider-specific message flows to data formats, and message flows utilised by the client interface; and a plurality of content-provider-protocol-specific plug-ins, each content-provider-protocol-specific plug-in defining rules for a mapping between the content-provider-specific data formats and content-provider-specific message flows of at least one of the plurality of content provider platforms, and the data formats and message flows utilised by the client interface.

Existing systems for integrating a plurality of supplier systems have the drawbacks of: needing an extensive amount of human intervention, and being not intuitive to use, both reasons of which cause the integration process lengthy and only persons with prominent levels of skills can use the existing systems to perform the integration efficiently.

### SUMMARY OF THE INVENTION

The above-mentioned drawbacks are overcome, and improvements are achieved, by the invention elaborated in the paragraphs that follow.

One aspect of the invention provides a system for integrating a plurality of supplier systems, each of which employs at least one application programming interface, by which a plurality of suppliers provides at least one product, said system comprising: a module for designing at least one template for the product; a module for establishing connection with the interface of the supplier system; a module for generating at least one action for a call of the interface, wherein each action includes a request envelope and a response envelope; a module for designing at least one flow of a plurality of actions; a module for mapping said request and response envelopes; and a module for generating a plurality of codes or classes based on the mapping, wherein the codes or classes are capable of including the supplier in the result of at least one search for the product.

Preferably, said template designer module defines at least one parameter for establishing the connection with the interface of the supplier system.

Advantageously, said connection establisher module defines types of connection and client, and specifies credentials of the connection.

Another aspect of the invention provides a computer system for integrating a plurality of supplier systems, each of which employs at least one application programming interface, by which a plurality of suppliers provides at least one product, said system comprising: a processor; a non-transitory processor-readable medium storing a set of executable instructions being configured in a way such that when said processor executes said instructions, said system is capable to: design at least one template for the product; establish connection with the interface of the supplier system; generate at least one action for a call of the interface, wherein each action includes a request envelope and a response envelope; design at least one flow of a plurality of actions; map said request and response envelopes; and generate a plurality of codes or classes based on the mapping, wherein the codes or classes are capable of including the supplier in the result of at least one search for the product.

Preferably, the set of executable instructions is also configured in a way such that when said processor executes said instructions, said system is capable to design at least one template for the product by defining at least one parameter for establishing the connection with the interface of the supplier system.

Advantageously, the set of executable instructions is also configured in a way such that when said processor executes said instructions, said system is capable to establish connection with the interface of the supplier system by defining types of connection and client, and specifying credentials of the connection.

Another aspect of the invention provides an apparatus for integrating a plurality of supplier systems, each of which employs at least one application programming interface, by which a plurality of suppliers provides at least one product, said apparatus comprising: a processor; a non-transitory processor-readable medium storing a set of executable instructions which comprises: a module for designing at least one template for the product; a module for establishing connection with the interface of the supplier system; a module for generating at least one action for a call of the interface, wherein each action includes a request envelope and a response envelope; a module for designing at least one flow of a plurality of actions; a module for mapping said request and response envelopes; and a module for generating a plurality of codes or classes based on the mapping, wherein the codes or classes are capable of including the supplier in the result of at least one search for the product.

Preferably, said template designer module defines at least one parameter for establishing the connection with the interface of the supplier system.

Advantageously, said connection establisher module defines types of connection and client, and specifies credentials of the connection.

Another aspect of the invention provides a method for integrating a plurality of supplier systems, each of which employs at least one application programming interface, by which a plurality of suppliers provides at least one product, comprising steps of: designing at least one template for the product; establishing connection with the interface of the supplier system; generating at least one action for a call of the interface, wherein each action includes a request envelope and a response envelope; designing at least one flow of a plurality of actions; mapping said request and response envelopes; and generating a plurality of codes or classes based on the mapping, wherein the codes or classes are capable of including the supplier in the result of at least one search for the product.

Preferably, said step of designing at least one template for the product includes a step of defining at least one parameter for establishing the connection with the interface of the supplier system.

Advantageously, said step of establishing connection with the interface of the supplier system includes a step of defining types of connection and client, and specifying credentials of the connection.

### DESCRIPTION OF THE PREFERRED EMBODIMENT

The invention will now be described in greater detail, by way of example, with reference to the accompanying drawings, in which:

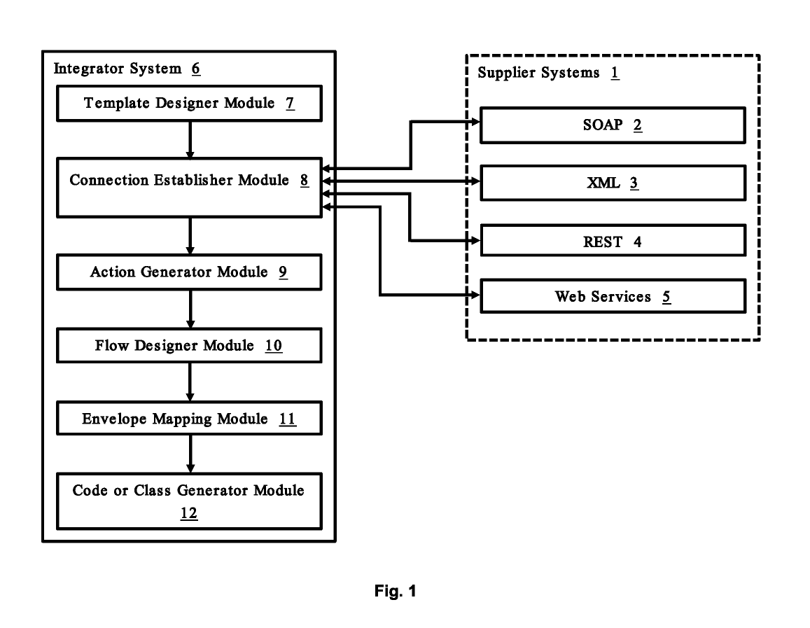

FIG. 1 is a schematic diagram of the system or apparatus, according to the invention, for integrating a plurality of supplier systems, each of which employs at least one application programming interface (hereinafter referred to as “API”), by which a plurality of suppliers provides at least one product; and

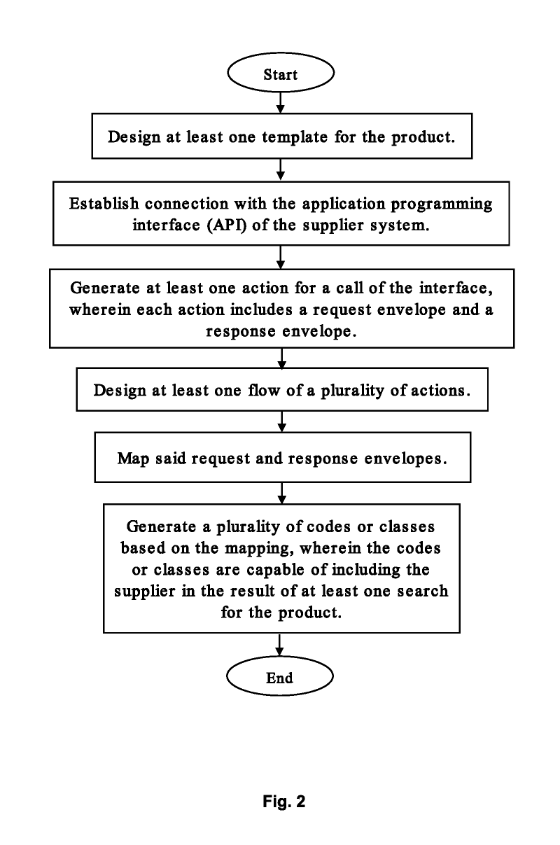

FIG. 2 is a flow chart of the method, according to the invention, for integrating a plurality of supplier systems, each of which employs at least one API, by which a plurality of suppliers provides at least one product.

The supplier systems 1 can employ any one or a combination of the APIs, such as SOAP 2, XML 3, REST 4, and web services 5. The products can be travel products like flights, hotels, and car hire.

Referring to FIG. 1, the integrator system 6 or apparatus comprises a template designer module 7, a connection establisher module 8, an action generator module 9, a flow designer module 10, an envelope mapping module 11, and a code or class generator module 12. Said template designer module 7 facilitates user to design at least one template for the product. The user designs the template by defining at least one parameter for establishing the connection with the interface of the supplier system. Said connection establisher module 8 facilitates the user to establish connection with the interface of the supplier system. The user establishes the connection by defining types of connection and client, and specifying credentials of the connection. Said action generator module 9 facilitates the user to generate at least one action for a call of the interface, wherein each action includes a request envelope and a response envelope. Said flow designer module 10 facilitates the user to design at least one flow of a plurality of actions. Said envelope mapping module 11 facilitates the user to map the request and response envelopes. Said code or class generator module 12 facilitates the user to generate a plurality of codes or classes based on the mapping, wherein the codes or classes are capable of including the supplier in the result of at least one search for the product.

Referring to FIG. 2, the method for integrating a plurality of supplier systems begins with a step in which user designs at least one template for the product. Next, the user establishes connection with the API of the supplier system. Then, the user generates at least one action for a call of the interface, wherein each action includes a request envelope and a response envelope. Next, the user designs at least one flow of a plurality of actions. Then, the user maps the request and response envelopes. The method ends with a step in which the user generates a plurality of codes or classes based on the mapping, wherein the codes or classes are capable of including the supplier in the result of at least one search for the product.

1. A system for integrating a plurality of supplier systems, each of which employs at least one application programming interface, by which a plurality of suppliers provides at least one product, said system comprising:
a module for designing at least one template for the product;
a module for establishing connection with the interface of the supplier system;
a module for generating at least one action for a call of the interface, wherein each action includes a request envelope and a response envelope;
a module for designing at least one flow of a plurality of actions;
a module for mapping said request and response envelopes; and
a module for generating a plurality of codes or classes based on the mapping, wherein the codes or classes are capable of including the supplier in the result of at least one search for the product.

2. A system as claimed in claim 1, wherein said template designer module defines at least one parameter for establishing the connection with the interface of the supplier system.

3. A system as claimed in claim 1, wherein said connection establisher module defines types of connection and client, and specifies credentials of the connection.

4. A computer system for integrating a plurality of supplier systems, each of which employs at least one application programming interface, by which a plurality of suppliers provides at least one produce, said system comprising:
a processor;
a non-transitory processor-readable medium storing a set of executable instructions being configured in a way such that when said processor executes said instructions, said system is capable to:
design at least one template for the product;
establish connection with the interface of the supplier system;
generate at least one action for a call of the interface, wherein each action includes a request envelope and a response envelope;
design at least one flow of a plurality of actions;
map said request and response envelopes; and
generate a plurality of codes or classes based on the mapping, wherein the codes or classes are capable of including the supplier in the result of at least one search for the product.

5. A computer system as claimed in claim 4, wherein the set of executable instructions is also configured in a way such that when said processor executes said instructions, said system is capable to design at least one template for the product by defining at least one parameter for establishing the connection with the interface of the supplier system.

6. A computer system as claimed in claim 4, wherein the set of executable instructions is also configured in a way such that when said processor executes said instructions, said system is capable to establish connection with the interface of the supplier system by defining types of connection and client, and specifying credentials of the connection.

7. An apparatus for integrating a plurality of supplier systems, each of which employs at least one application programming interface, by which a plurality of suppliers provides at least one product, said apparatus comprising:
a processor;
a non-transitory processor-readable medium storing a set of executable instructions which comprises:
a module for designing at least one template for the product;
a module for establishing connection with the interface of the supplier system;
a module for generating at least one action for a call of the interface, wherein each action includes a request envelope and a response envelope;
a module for designing at least one flow of a plurality of actions;
a module for mapping said request and response envelopes; and
a module for generating a plurality of codes or classes based on the mapping, wherein the codes or classes are capable of including the supplier in the result of at least one search for the product.

8. An apparatus as claimed in claim 7, wherein said template designer module defines at least one parameter for establishing the connection with the interface of the supplier system.

9. An apparatus as claimed in claim 7, wherein said connection establisher module defines types of connection and client, and specifies credentials of the connection.

10. A method for integrating a plurality of supplier systems, each of which employs at least one application programming interface, by which a plurality of suppliers provides at least one product, comprising steps of:
designing at least one template for the product;
establishing connection with the interface of the supplier system;
generating at least one action for a call of the interface, wherein each action includes a request envelope and a response envelope;
designing at least one flow of a plurality of actions;
mapping said request and response envelopes; and
generating a plurality of codes or classes based on the mapping, wherein the codes or classes are capable of including the supplier in the result of at least one search for the product.

11. A method as claimed in claim 10, wherein said step of designing at least one template for the product includes a step of defining at least one parameter for establishing the connection with the interface of the supplier system.

12. A method as claimed in claim 10, wherein said step of establishing connection with the interface of the supplier system includes a step of defining types of connection and client, and specifying credentials of the connection.

13. A system as claimed in claim 2, wherein said connection establisher module defines types of connection and client, and specifies credentials of the connection.

14. A computer system as claimed in claim 5, wherein the set of executable instructions is also configured in a way such that when said processor executes said instructions, said system is capable to establish connection with the interface of the supplier system by defining types of connection and client, and specifying credentials of the connection.

15. An apparatus as claimed in claim 8, wherein said connection establisher module defines types of connection and client, and specifies credentials of the connection.

16. A method as claimed in claim 11, wherein said step of establishing connection with the interface of the supplier system includes a step of defining types of connection and client, and specifying credentials of the connection.
